(19) United States
(12) Patent Application Publication
(10) Pub. No.: US 2010/0018803 A1
(43) Pub. Date: Jan. 28, 2010

(54) Ladder Safety Apparatus and Method

(76) Inventors: Donald R. Schwenke, Acton, CA (US); Michael R. Cinquemani, Acton, CA (US)

Correspondence Address: LAWRENCE S. COHEN, ESQ.;LAW OFFICE OF LAWRENCE S. COHEN, 10960 WILSHIRE BLVD, SUITE 1220, LOS ANGELES, CA, 90024, US

(21) Appl. No.: 12/507,770

(22) Filed: Jul. 22, 2009

Related U.S. Application Data
(60) Provisional application No. 61/129,817, filed on Jul. 22, 2008.

(51) Int. Cl. E06C 1/34

(52) U.S. Cl. 182/206

(57) ABSTRACT

An apparatus that fits onto a ladder for securing the ladder safely to a circular pole. The apparatus has a pair of curved arms that are each rotatable about a pivot so that they will close onto a pole. The arms are caused to rotate by a lever portion that contacts the pole as the ladder is forced toward the pole such as when it is set up and when a climber begins to climb the ladder. As the lever portion is forced against the pole the curved arm rotates to enclose the pole. The arms have a symmetrical control element in the form of meshed gears so that they act symmetrically as they are set up initially and as they rotated into the enclosing position.

### PRIORITY CLAIM

Priority is claimed from U.S. Provisional Application Ser. No. 61/129,817 filed on Jul. 22, 2008 the content of which is incorporated herein by reference.

### BACKGROUND

Ladder safety has been a long standing and is an important consideration. It is addressed in OSHA Standard 1926.1053.

One important aspect of ladder safety is the placement of ladders against circular structures such as utility poles, electrical poles, tree trunks, etc.

The problem is that the straight rung of a ladder, when placed on a circular, or any curved surface creates instability. Also, even if both ladder rails can contact the pole, if only one does, the ladder erection is unstable; and then also, even if both rails contact the pole, it can be unstable

While the problem is well known, solutions have been few and inadequate. There is a need for a reliable way to place a ladder against a round pole or the like in a secure manner.

### BRIEF DESCRIPTION OF THE DRAWINGS

FIGS. 1a and 1b and 1c show how a ladder can be positioned on a pole in unstable positions.

FIG. 2 shows a side view of an embodiment of the invention.

FIG. 3 shows a top view of an embodiment of the invention.

FIG. 4 shows a perspective view of an embodiment of the invention.

FIG. 5 shows a front partial exploded view of an embodiment of the invention.

FIG. 6 shows a perspective exploded view of an embodiment of the invention.

FIG. 7 shows a close-up view of an embodiment of the invention

FIG. 8 shows a view of an embodiment of the invention in the open position relative to a pole.

FIG. 9 shows a view of an embodiment of the invention in the closed position.

FIG. 10 shows an embodiment of the invention in use.

FIG. 11 shows an embodiment of the invention in use.

### DETAILED DESCRIPTION

The invention resides in an apparatus that can be attached to a ladder and that has gripping arms as part of a mechanism in which the gripping arms move into a position engaging around a pole as the ladder is set up. One feature of the invention is a pair of gripping arms that have a concave curved portion for engaging around a pole and each gripping arm having a lever portion that will engage the pole upon erecting the ladder and will cause the gripping arms to pivot into an enclosing position. Another feature of the invention is a mechanism that places the gripping arms in a symmetrical position and also places the levers in a symmetrical position and then causes the levers and consequently the gripping arms to move in unison from an open position to a closed position around a pole and maintaining the correct symmetry of the ladder and the pole for stability, with the gripping arms enclosing the pole. The mechanism also has a mounting structure that enables placement of the apparatus in a correct position on the ladder. It is designed to attach to any extension ladder and allows the ladder user to climb any kind of pole (i.e. electric pole, light pole, tree trunk, etc.) and be able to securely climb the pole, or circular structure.

Embodiments of the invention will now be described in conjunction with the figures.

The term pole adequately defines most applications of the invention. Examples are utility poles and other upstanding structures that have an exterior curvature that can be secured by enclosing engagement of a pair of gripping arms. Typical of such poles are those of circumference that will fall inside the rails of a ladder; that is in which the curvature is such that the pole can contact the ladder's uppermost rung but not the ladder rails resulting in undesired instability. If the curvature is slight enough that the ladder rails will make contact and not the rung, then instability may still be present, for example if the ladder is erected with only one rail in contact initially (the ladder can twist as the user climbs so that both rails touch, but it is still unstable).

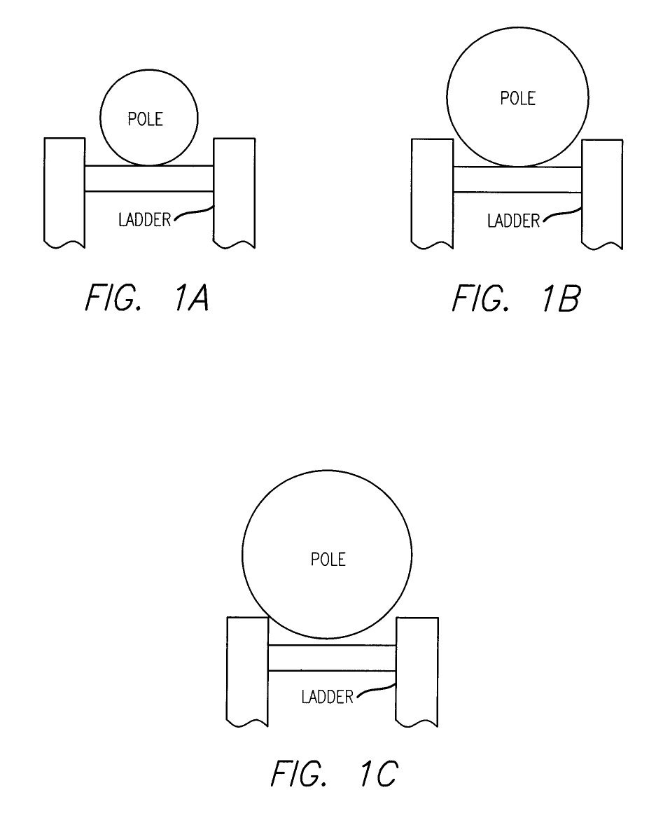

For cases in which the pole contacts the rung, there are two possible configurations. A pole may have its entire circumference (assuming circular) inside the width of the ladder rails, or the circumference may extend beyond the rails. FIGS. 1a and 1b illustrate typical arrangements of that type of configuration that the present invention is intended to avoid. In FIG. 1a the pole is fully inside the ladder rails. In FIG. 1b the curvature extends outside the ladder rails, but does not touch either rail (although it could touch one rail, which would be a very unstable ladder set-up). FIG. 1c is a configuration in which the pole curvature is so slight that it will not touch the rung, but only one or both rails. This is also an undesirable ladder set-up if only one rail is in contact, the ladder will twist as the user climbs, making it unstable.

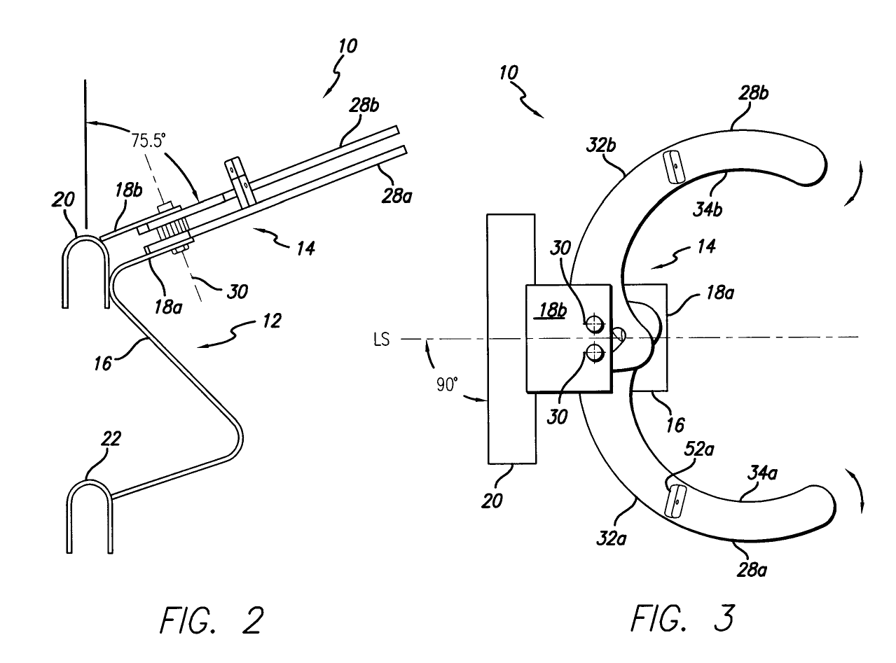

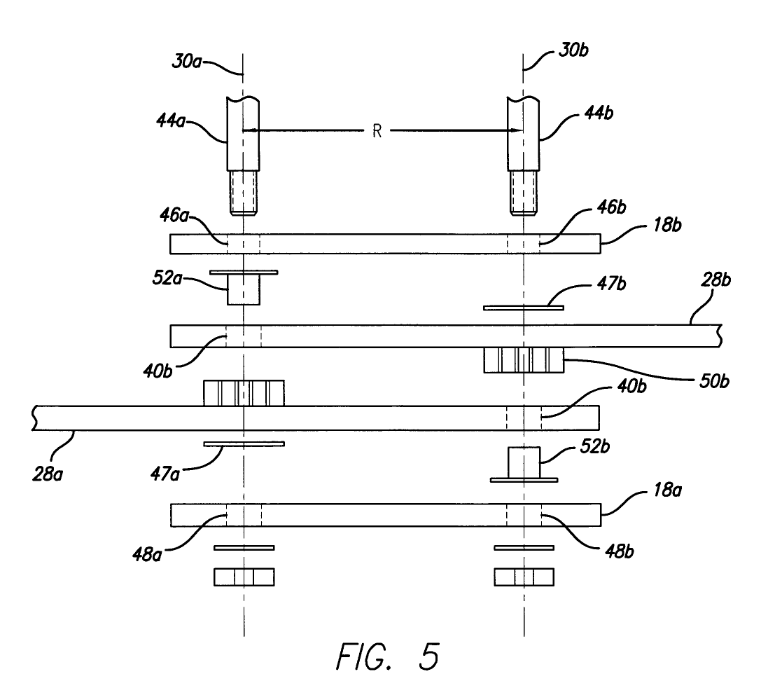

The following description is with reference to FIGS. 2-7. It will be seen that the numbering system uses an “a” designation for one side and a “b” designation for the other side when there is parity of the parts described. However when both are referred to, the “a” and “b” distinction may be omitted. The safety device 10 can be described as having two general portions, a frame portion 12 and an operating portion 14. The frame portion 12 has two elements, a support beam 16 which as shown has a reversed Z shape including a plate called a lower mounting plate 18a. The frame portion also has an upper mounting plate 18b. The support beam 16 serves to locate ladder mounting members, upper ladder mounting member 20 and lower ladder mounting member 22 and the operating portion 14. The upper mounting plate 18b is parallel to the lower mounting plate 18a. The operating portion 14 is mounted on the plates 18a and 18b. All of the upper and lower ladder mounting members 20 and 22, the support beam 16 and the upper plate 18b are welded together and as will be seen, locate the parts for correct mounting on a ladder and operation.

The upper and lower ladder mounting members 20 and 22 are elongated U-shaped channel channels 20 and 22, attached to the support beam 16 and adapted to that fit over adjacent ladder rungs. They are each equipped with a pair of positive lock pins 24 such as Positive Lock Pins made by Pivot Point, Inc of Hustisford, Wis..

The operating portion 14 is attached to the frame portion 12 on the parallel plates 18a and 18b. The operating portion 14 has a pair of inwardly (concave) curved claws or calipers 28. The calipers 28 are identical and are mounted as mirror images in vertically staggered relationship. Each caliper 28 has a pivot point 30 which defines, “outside the pivot point”, an outer or gripping portion 32a which has a concave curve 34 and which also defines, “inside the pivot point” a lever portion 36. The lever portion 36 has a curved camming surface 38. Each caliper 28 also has a slot 40 which is shaped on a radius R from the pivot point 30 of the other caliper which is also the distance between the pivot points.

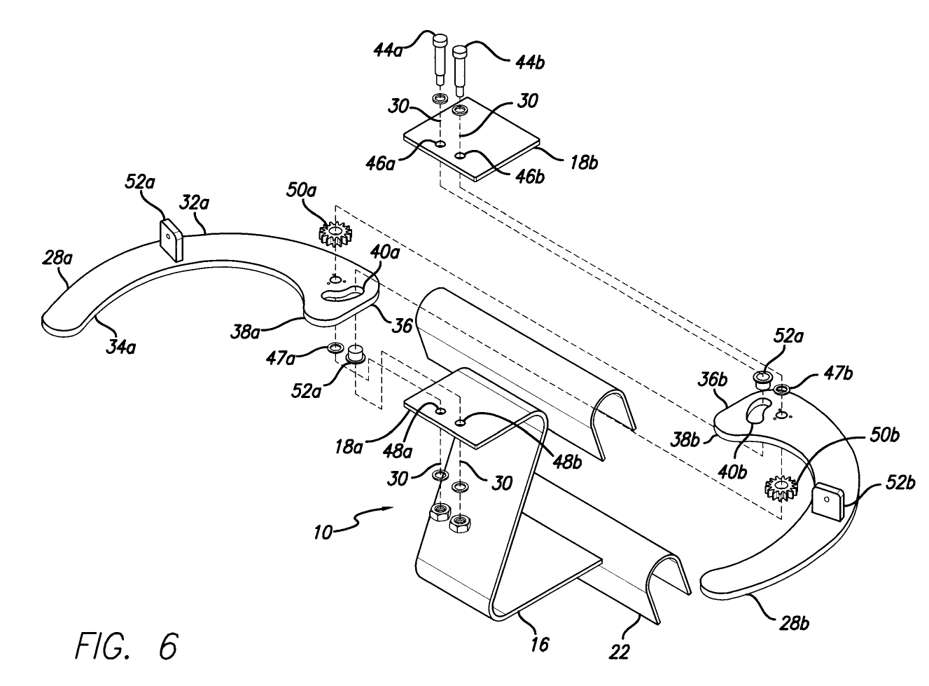

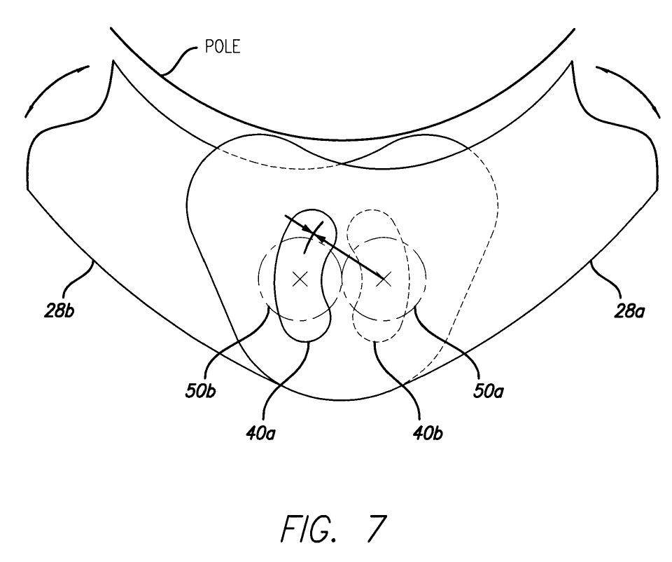

The calipers 28 are mounted between the plates 18a and 18b. They are mounted on shoulder bolts 44a and 44b extending through holes 46a and 46b in the plate 18b and holes 48a and 48b in plate 18a, which holes are centered at the pivot points 30 of the calipers 28 and which are separated by the distance R. Each caliper has a gear 50a and 50b attached to it at its pivot point, the gears 50a and 50b being meshed. There is a Nylon hat washer 52a and 52b at each pivot point 30 mounted on the respective shoulder bolt 44a and 44b and serving as a bearing in the slot 40 through which it passes. Other Nylon washers 47a and 47b are fitted for normal bearing and spacing purposes. The shoulder bolts 44a and 44b are secured by nuts and washers as shown in FIGS. 5 and 6.

Mounting of the gear 50a on caliper 28a and gear 50b on caliper 28b is not detailed, but they can be screwed on by tapping holes in them and with countersunk screws. In installing the gears 50a and 50b, their mesh placement must be set or “clocked” to put the calipers into symmetry as described below.

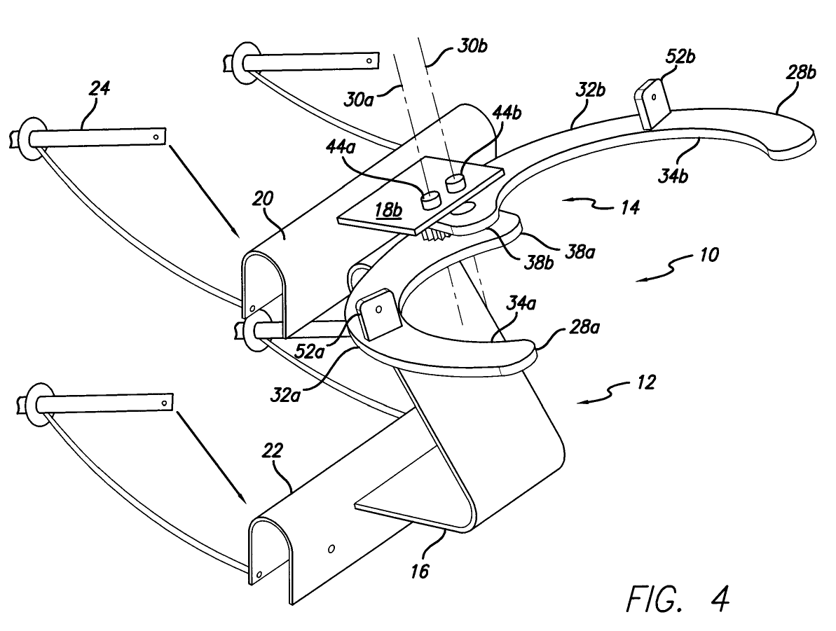

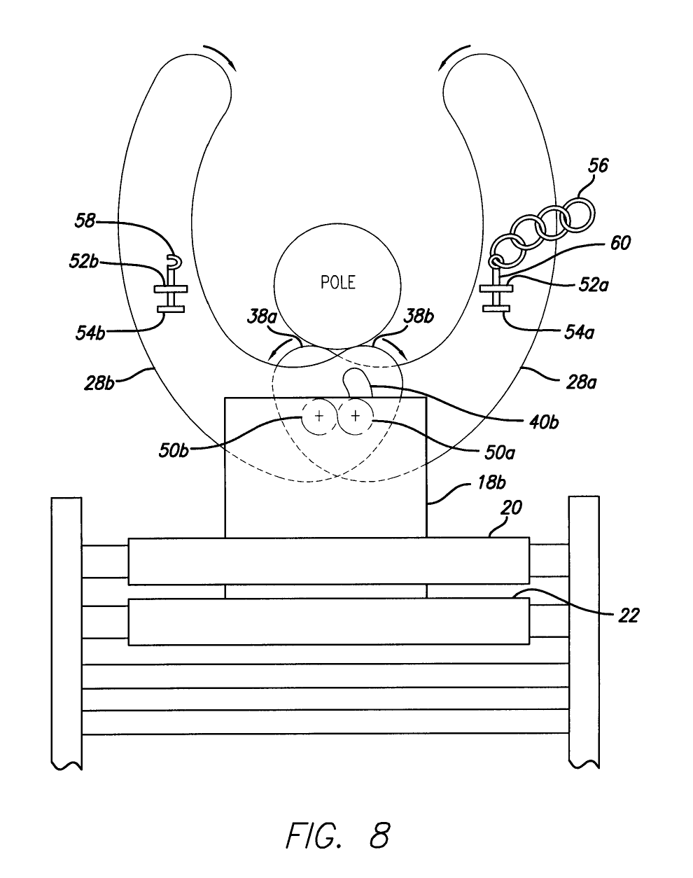

With assembly the calipers will rotate together on their respective pivot points 30, as will be described in more detail below. For the best and safest operation, the calibers must be mounted for symmetrical movement and symmetrical position relative to the ladder and the prospective pole. That movement is obtained by the gears 50a and 50b being fitted to their respective calipers 28 for meshing symmetrically with respect to a center line also called a line of symmetry, LS (see FIGS. 3 and 7). That is, the calipers 28a and 28b are set for symmetrical placement and pivoting with respect to the line of symmetry LS and the gears 50a and 50b are meshed to establish maintain the symmetry of the calipers. The line of symmetry LS passes through the gears' pitch circles where they mesh (see FIG. 7). Therefore, the gears 50a and 50b will control the calipers 28a and 28b to move symmetrically together, toward and away from the line of symmetry LS. The line of symmetry LS should also be perpendicular to a length axis defined by the U-shaped channels 20 and 22, which renders line of symmetry perpendicular (see FIG. 3) to a length axis of ladder rungs when the device is set onto a ladder. With this structure the positioning and the movement of the calipers will be symmetrical with each other and with ladder rungs. That will result in the pole being gripped centrally of the device and symmetrically relative to the axis of the ladder rungs

There is another mechanical feature that requires that the outermost point on the camming surfaces 38a and 38b that is, the point in contact with the pole must always remain on its side (the inside) of its pivot point, that is it must never go “overcenter”, in order to provide the pivoting force needed to rotate the calipers. The overcenter position could occur if the calipers are spread too far apart, causing the camming surfaces to rotate too far.

In order to accommodate correct use of ladders according to OSHA standard 1926.1053, the device 10 is made so that the calipers will extend with respect to the U-shaped channel channels 20 and 22 at an angle of 75.5°, which is shown on FIG. 2. This will put the calipers in the best horizontal position relative to a vertical pole.

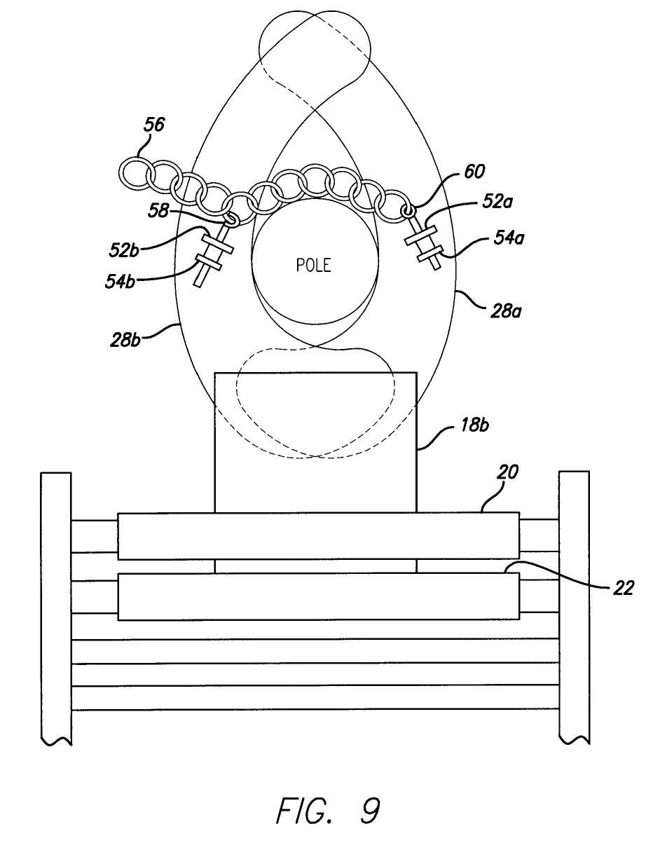

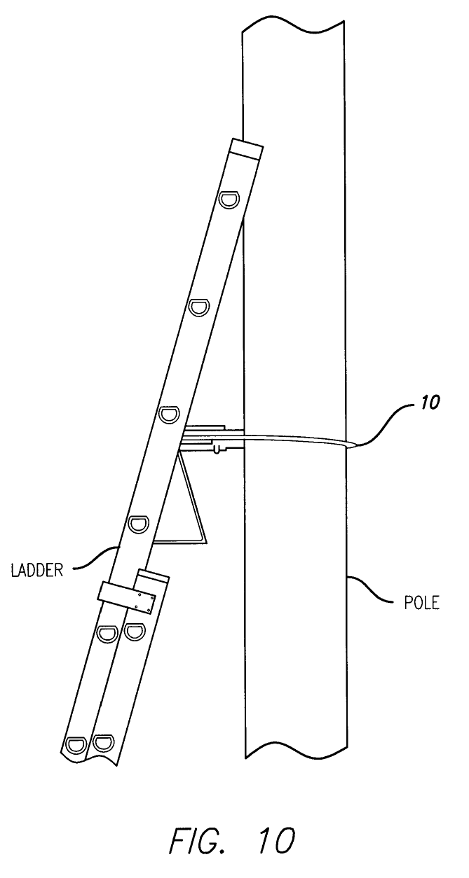

FIGS. 8 and 9 show the device set initially in position (FIG. 8) and then in its installed position (FIG. 9). In FIG. 8, the calipers are open and the camming surfaces 38a and b are in contact with a pole. As the ladder is forced against the pole the calipers will rotate as shown by the arrows, into the position shown in FIG. 9.

After a ladder is erected on a pole it should be secured in place. This is provided by a line and a retaining assembly that attaches to each caliper and has a line extending around the pole. It can be tightened on one or both sides. An exemplary embodiment is shown in FIGS. 8 and 9 in which lugs 52a and b are welded to the calipers 28a and b at a selected point that will give a good amount of contact with the pole by a securing line. Mounted on the lugs are tensioners 54a and b. A line is attached in a fixed manner to one tensioner and in a selectable manner to the other tensioners. The tensioners can be tightened. In the embodiment shown, the line is a chain 56. The tensioners are a threaded knob and one tensioner has an open hook 58 while the other one has an eye bolt 60. The chain 56 is fixed at one end on the eye bolt 60. In use, before the ladder is erected, the tensioners should be set in their most loose position. After the ladder is set up and the user has climbed up, the chain 60 is wrapped around the pole and a link inserted in the open hook 58, as tightly as is practical. Then the tensionsers are tightened to fully secure the chain.

FIG. 12 shows a gripping arm 64 which is configured for a square pole. This arm in a left and right placement as in the configuration above will work the same way the curved arms do.

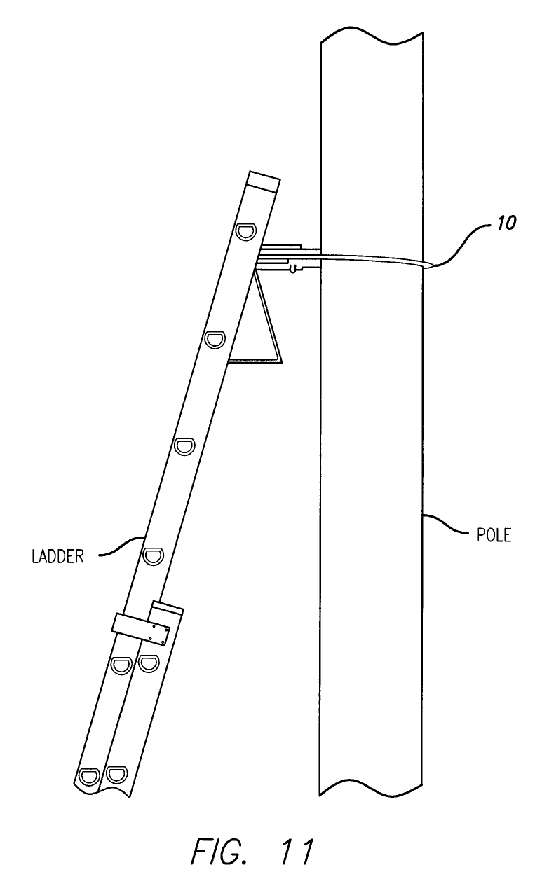

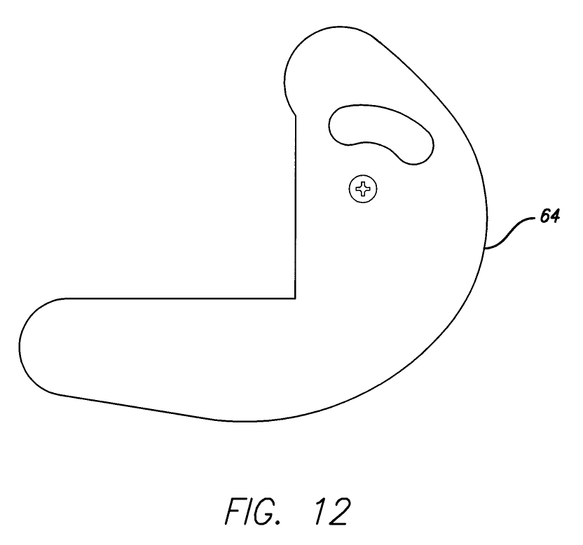

In use the ladder safety device 10 is mounted on a ladder as shown in FIGS. 10 and 11. It can be mounted on either the first and second ladder rungs, or on a lower pair such as the second and third, or the third and fourth. In FIG. 10 it is shown mounted on the third and fourth rungs and in FIG. 10 it is shown mounted on the first and second rungs. It attaches to the rungs of the ladder in seconds by way of hanging the U-shaped channels over the rungs. Then the positive lock pins are inserted to keep the device in place while standing up the ladder for use. For the most stable set up the device should be installed on a ladder mid-way of the length of the rungs. That is the U-shaped channels should be centered on the rungs.

As the ladder is tilted toward the pole the camming surfaces 38 contact the pole surface and as force is placed on the ladder the lever portions 36 will rotate around the pivot points 30, which rotation is symmetrical due to the operation of the gears 50a and 50b, which in turn will cause the calipers 28 to symmetrically enclose the pole.

The symmetrical operation of the embodiment described above has been found to be important to avoid instability in the enclosing process by ensuring that the pole is centered on the device and at right angles to the ladder rungs. Absent this symmetry the ladder can slip and be unstable during the enclosing operation and after the ladder is erected.

The mechanism for symmetrical rotation of the calipers can be any mechanism that causes controlled contra-rotation of the calipers by a symmetrical engagement and contra-rotational movement on the inside of the pivot point.

However, the unit can be constructed without the gears in which case the calipers 28 will still pivot, but they will function independently, and at a greater risk of instability in the ladder being put in place as well as in the final position.

The foregoing Detailed Description of exemplary and preferred embodiments is presented for purposes of illustration and disclosure in accordance with the requirements of the law. It is not intended to be exhaustive nor to limit the invention to the precise form or forms described, but only to enable others skilled in the art to understand how the invention may be suited for a particular use or implementation. The possibility of modifications and variations will be apparent to practitioners skilled in the art. No limitation is intended by the description of exemplary embodiments which may have included tolerances, feature dimensions, specific operating conditions, engineering specifications, or the like, and which may vary between implementations or with changes to the state of the art, and no limitation should be implied therefrom. This disclosure has been made with respect to the current state of the art, but also contemplates advancements and that adaptations in the future may take into consideration of those advancements, namely in accordance with the then current state of the art. It is intended that the scope of the invention be defined by the Claims as written and equivalents as applicable. Reference to a claim element in the singular is not intended to mean “one and only one” unless explicitly so stated. Moreover, no element, component, nor method or process step in this disclosure is intended to be dedicated to the public regardless of whether the element, component, or step is explicitly recited in the Claims. No claim element herein is to be construed under the provisions of 35 U.S.C. Sec. 112, sixth paragraph, unless the element is expressly recited using the phrase “means for . . . ” and no method or process step herein is to be construed under those provisions unless the step, or steps, are expressly recited using the phrase “comprising step(s) for . . . ”

1. A ladder safety device for erecting a ladder against a circular or curved surface such as a pole comprising;
a frame portion adapted to assemble rung mounting elements and an operating element;
a pair of rung mounting elements attached to the frame portion spaced apart to mount to selected ladder rungs and;
an operating portion assembled on the frame portion comprising;
a pair of calipers being pivotably mounted to the frame portion at parallel spaced apart pivot points and an arm extending outside of the pivot point of each caliper with a concave inward facing curved surface and defining a working area between the inward facing curves of the arms and each caliper having a lever portion on the opposite side of the pivot point having a convex curved surface facing into the working area; whereby upon moving the lever arms against a curved surface structure such as a pole within the working area, the lever portions will cause the calipers to rotate toward each other to enclose the structure.

2. The ladder safety device of claim 1 further wherein:
the calipers each have a gear at the pivot point, the gears having the same pitch circle dimension and being in meshed relationship whereby the lever portions and the arms will rotate together.

3. The ladder safety device of claim 2 further wherein the gears are meshed such that the calipers are positioned and movable symmetrically with respect to a line of symmetry through the mesh point of the gear pitch circles.

4. The ladder safety device of claim 3 further wherein the rung mounting elements are adapted to have ladder rungs perpendicular to the line of symmetry when the device is mounted on a ladder.

5. The ladder safety device of claim 4 wherein the pivot point of each caliper is on the side of the line of symmetry opposite that of the gripping arms, and the calipers are mounted in overlapping relationship and each having a slot in its line of movement past the pivot point of the other caliper.

6. The ladder safety device of claim 5 wherein the slots on each caliper have one end that provides a stop for preventing pivoting of the other caliper beyond a point of leverage for its lever portion with respect to its pivot point.

7. The ladder safety device of claim 1 further wherein the rung mounting elements are elongated channels closed at the top and open at the bottom whereby they may be set down on ladder rungs to fix the position of the device on the ladder.

8. The ladder safety device of claim 7 wherein the rung mounting elements are each equipped with a securing device to prevent dislodging from a ladder rung on which it has been placed.

9. The ladder safety device of claim 8 wherein the securing device comprises at least one positive lock pin attached to each rung mounting element and each rung mounting element has holes to allow its capture on a ladder rung.

10. The safety ladder of claim 1 further wherein each gripping arm has mounted on it an adjustable screw and a capture loop, and an elongated flexible member fixed to one loop and attachable at selected points on its length to the other loop.

11. The ladder safety device of claim 10 wherein one of said capture loops is closed and has a chain attached to it and the other capture loop is open and adapted to capture a selected chain link.

12. A method for erecting and using a ladder safely on a pole comprising:
providing a ladder safety device as in claim 1;
tilting the ladder into place with the gripping arms in an open position to each side of the pole;
causing the lever portions to be pushed against the pole such that the gripping arms rotate into contact with the pole.

13. The method of claim 12 further comprising:
providing on each gripping arm an adjustable screw and a capture loop, and an elongated flexible member fixed to one loop and attachable at selected points on its length to the other loop and
applying the flexible member around the pole and fixing it to the other capture loop to firmly hold the safety device to the pole.

14. A ladder safety device comprising:
a frame portion adapted to assemble rung mounting elements and an operating element;
a pair of rung mounting elements attached to the frame portion spaced apart to mount to selected ladder rungs said rung mounting elements comprising elongated channels closed at a top side and open at a bottom side and;
an operating portion assembled on the frame portion comprising;
a pair of calipers being pivotably mounted to the frame portion at parallel spaced apart pivot points and a gripping arm extending outside of the pivot point of each caliper the gripping arm having a concave inward facing curved surface and defining a working area between the inward facing curves of the gripping arms and each caliper having a lever portion on the opposite side of the pivot point the lever portion having a convex curved surface facing into the working area;
the calipers being mounted with respect to a line of symmetry extending between the pivot points and wherein the pivot point of each caliper is on the side of the line of symmetry opposite to the gripping arms, the calipers being mounted in overlapping relationship and each having a slot shaped to follow the pivot point of the other caliper and the slots having a length to provide a stop for pivoting of the other caliper at a maximum open position and the maximum open position being defined such that the lever portion is at an angle to the pivot point to provide a rotating force vector when the device is moved against a pole which contacts the lever portion;
a means for providing symmetrical movement of the calipers;
a means extending through the slot in each caliper and said means providing pivoting control for each caliper.
whereby upon tilting a ladder on which the device is mounted against a pole the lever portions will cause the gripping arms to rotate toward each other to enclose the pole.
